(19) United States
(12) Patent Application Publication
(10) Pub. No.: US 2017/0038273 A1
(43) Pub. Date: Feb. 9, 2017

(54) Device for Detecting a Parameter of a Gas, Method for Operating Such a Device, and Measuring System for Determining a Parameter of a Gas

(71) Applicant: Robert Bosch GmbH, Stuttgart (DE)

(72) Inventors: Andreas Krauss, Tuebingen (DE); Christoph Schelling, Stuttgart (DE)

(21) Appl. No.: 15/304,165

(22) PCT Filed: Apr. 9, 2015
(86) PCT No.: PCT/EP2015/057716

§ 371 Date: Oct. 14, 2016

(30) Foreign Application Priority Data
Apr. 17, 2014 (DE) 10 2014 207 480.0

(51) Int. Cl. G01L 23/24; G01L 23/18; G01L 23/10; G01N 27/406; G01N 27/407

(52) U.S. Cl. CPC G01L 23/24; G01N 27/4067; G01N 27/407; G01L 23/10; G01L 23/18

(57) ABSTRACT

A device for detecting a parameter of a gas includes a body defining at least one cavity, at least one membrane, and at least one pressure measuring element. The cavity is configured to receive a gas from an outer area. The at least one membrane is configured to separate the cavity from the outer area. A first side of the at least one membrane facing toward the outer area includes a first layer of an electrically conductive material, and a second side of the at least one membrane facing toward the cavity and opposite the first side includes a second layer of the electrically conductive material. At least one portion of the at least one membrane includes an ion-conductive material. The at least one pressure measuring element is positioned on the at least one membrane, and is configured to detect a pressure of the gas in the cavity.

### PRIOR ART

The present invention relates to a device for detecting a parameter of a gas, to a measuring system for determining a parameter of a gas, to a method for operating a device for detecting a parameter of a gas, to a corresponding device and to a corresponding computer program.

Exhaust gas sensors for detecting oxygen or nitrogen oxides are currently produced almost exclusively by ceramic technology, or LTCC (low-temperature cofired ceramics). Active layers, which are used as ion conductors, are in this case usually made of yttrium oxide-stabilized zirconium oxide (YSZ) and are combined with further layers, for example aluminum oxide-based insulation layers or conductive layers, for example of Pt which by means of metal paste printing is structured and burnt in.

There are also concepts for the construction of solid electrolyte-based micromechanical sensors, in which the electrical currents are proportional to the ionic currents through the electrolyte.

Furthermore, pressure sensors are known which can measure small pressure differences, or even absolute pressures, with very high resolution by means of a deformable membrane, a gas-tight cavity with a constant enclosed amount of gas being used for the absolute pressure measurement. Known processes for the production of cavities, which could be suitable inter alia for use in the sensors, are for example an APSM process or processes based on SOI.

DE 102004036032 A1 discloses a method for producing a semiconductor component, in which, by means of a first epitaxy layer which is applied to a semiconductor carrier, a membrane is produced with first doping above a region in the semiconductor carrier, and a structured stabilization element is applied to the semiconductor carrier by means of a second epitaxy layer which is applied to the semiconductor carrier.

### DISCLOSURE OF THE INVENTION

Against this background, with the approach proposed here, a device for detecting a parameter of a gas, a measuring system for determining a parameter of a gas, a method for operating a device for detecting a parameter of a gas, as well as a device which uses this method, and lastly a corresponding computer program, according to the main claims are provided. Advantageous configurations may be found in the respective dependent claims and the description below.

A device for detecting a parameter of a gas, having a cavity for receiving the gas, comprises two layers of an electrically conductive material on opposite sides of an ion-conducting membrane covering the cavity, as well as a pressure measuring element arranged on the membrane. In this way, it is possible to produce a combined sensor consisting of a pressure sensor and a gas sensor based on an electrical voltage between the layers of the electrically conductive material.

A sensor device constructed according to the concept proposed here makes it possible to improve the detection of gases that can be measured directly and indirectly by means of ion-conducting materials, i.e. for example oxygen or pollutant gases such as nitrogen oxides, particularly in the exhaust gas of, for example, a vehicle.

In one refinement of the approach proposed here, instead of an instantaneous measurement of small gas concentrations, a measurement mode integrating over time, which requires little outlay, may be carried out. In this way, it is possible to take into account current exhaust gas standards which require integrated values, for example detection over a particular driving distance, instead of detection of instantaneous concentrations. In a sensor device produced according to the concept proposed here, it is also possible to use electrical currents between the electrically conductive layers, which do not necessitate amplification and/or shielding. In this way, the outlay for a downstream measurement can be reduced effectively.

The proposed concept furthermore makes it possible to reduce the power consumption and the heating time of the sensors, for example by bringing only the ion-conducting layers, and not the sensors as a whole, to operating temperature by means of a heater during operation of the device. By virtue of very rapid heating, which is thereby possible, an installation site of the sensors can be selected freely, for example at a large distance from high exhaust gas temperatures of a vehicle engine, which are unfavorable for a housing of the device. As a further advantage, in a refinement of the proposed concept, the use of one of the electrically conductive layers on the ion-conducting element as an electrode and as a heating structure allows significantly simplified construction with lower costs and increased reliability.

A device for detecting a parameter of a gas is provided, the device having the following features:

at least one cavity for receiving the gas from an external space;

at least one membrane for separating the cavity from the external space, a first side of the membrane, facing toward the external space, comprising a first layer of an electrically conductive material, and a second side, facing toward the cavity and lying opposite the first side, of the membrane comprising a second layer of an electrically conductive material, and at least one section of the membrane comprising an ion-conducting material; and

at least one pressure measuring element, arranged on the membrane, for detecting a gas pressure in the cavity.

The device may be a sensor device for determining a gas concentration, for example in the exhaust gas of a vehicle. To this end, one or more parameters of the gas may be detected, for example a value of a pump current required in order to pump the gas into the cavity, and/or a gas pressure of the gas contained in the cavity. The at least one cavity may applied in the form of a trough in a substrate for carrying individual elements of the device, for example by an etching process carried out on a surface of the substrate. The external space may refer to an environment lying outside the cavity. The external space may extend between the membrane and a housing of the device, or beyond the latter. An ambient pressure may prevail in the external space. The membrane may be produced and formed from a material which allows elastic deformation, in order to form a curvature in the direction of the external space in a manner corresponding to a gas pressure inside the cavity. In particular, the membrane may be formed by means of the ion-conducting material in order to allow diffusion of the gas between the external space and the cavity. The first and second layers of an electrically conductive material may be metal layers to which an electrical potential can be applied via electrical contact terminals arranged on them, and/or from which an electrical potential can be tapped via the contact terminals. The pressure measuring element may, for example, be arranged and formed on the side of the membrane facing toward the external space, in order to detect the gas pressure piezoelectrically and/or piezoresistively. For example, the pressure measuring element may be a strain gauge, or the pressure measuring element may comprise a strain gauge.

According to one embodiment of the device, the first layer of an electrically conductive material, the membrane and the second layer of an electrically conductive material may be configured in order to pump the gas through the membrane when an electrical voltage is applied between the first layer and the second layer. As an alternative or in addition, the first layer of an electrically conductive material, the membrane and the second layer of an electrically conductive material may be configured in order to generate an electrical voltage between the first layer and the second layer in the event of diffusion of the gas through the membrane. In this way, by means of detection of a pump current pumping the gas from the external space into the cavity and/or from the cavity into the external space, and as an alternative or in addition by means of tapping an electrical voltage based on diffusion of the gas, it is readily possible to deduce a composition of the gas.

In particular, the first layer of an electrically conductive material and/or the second layer of an electrically conductive material may comprise a gas-permeable noble metal. In this way, gas permeability of the membrane, or of the ion-conducting section of the membrane, can advantageously be maintained.

According to another embodiment, the first layer of an electrically conductive material and/or the second layer of an electrically conductive material may comprise a first electrical contact terminal and a second electrical contact terminal, and be configured accordingly in order to heat at least a section of the membrane on the basis of an electrical current flow between the first electrical contact terminal and the second electrical contact terminal. An amount of heat required for heating the membrane may be generated in a straightforward way by applying different electrical potentials to the first and second electrical contact terminals. Thus, it is possible to omit a heating element in the device and thereby save on cost and installation space.

In particular, the pressure measuring element may be arranged outside the section, to be heated, of the membrane. In this way, it is readily possible to ensure that a measurement functionality of the pressure measuring element cannot be impaired by temperature variations or temperatures that damage the pressure measuring element.

According to one particular embodiment, the first layer of an electrically conductive material and/or the second layer of an electrically conductive material may be arranged in a meandering shape, for example extending in a meandering shape a plane essentially parallel to the first and second sides of the membrane. In particular, the electrically conductive material layer which is used for heating the section of the membrane may have the meandering profile. It is thus possible to provide, in a straightforward and robust way, an extended heating section for optimal heating of the membrane. Furthermore, when a material which is not gas-permeable is used for the layers of an electrically conductive material, exposed regions for passage of gas can be provided.

The device may comprise a stop element for limiting a deflection of the membrane. The stop element may, in particular, be arranged on a bottom of the cavity. With this embodiment, damage to the membrane can be avoided in a straightforward and economical way.

According to another embodiment, the device may comprise at least one second pressure measuring element. The second pressure measuring element may be arranged at a further position, different to a position of the pressure measuring element, on the membrane. In this way, by detecting the gas pressure at different positions of the membrane, it is possible to determine the gas pressure prevailing in the cavity even more accurately. In particular, a detection direction of the pressure measuring element may be different to a detection direction of the further pressure measuring element. The detection direction may be a direction in which the pressure measuring element experiences a physical and/or chemical change during the recording of a measurement quantity. If the pressure measuring element is configured as a strain gauge, for example, the detection direction may correspond to an expansion direction of the strain gauge. This special refinement of this embodiment allows even more accurate determination of the gas pressure.

According to one particular embodiment, the device may comprise at least one further cavity for receiving the gas from the external space, at least one further membrane for separating the further cavity from the external space, and at least one further pressure measuring element, arranged on the membrane, for detecting a gas pressure in the further cavity. In this case, a first side of the further membrane, facing toward the external space, may have a further first layer of an electrically conductive material, and a second side, facing toward the further cavity and lying opposite the first side, of the further membrane may have a further second layer of an electrically conductive material. At least one section of the further membrane may comprise the ion-conducting material. With this embodiment, two or more sensor elements can be integrated on the device. By the sensor elements being usable independently of one another for the measurement process, a function test of the individual sensor elements can be carried out in a straightforward way. In particular, by using temporally offset and/or rotating individual sensor elements, it is possible to produce a mode integrating over time for the detection of the gas.

A measuring system for determining a parameter of a gas is furthermore provided, wherein the measuring system has the following features:

the device as described in one of the above-mentioned embodiments; and

an evaluation instrument, the evaluation instrument being coupled to the first layer and/or the second layer of an electrically conductive material and/or the pressure measuring element, and being configured in order to determine the parameter of the gas on the basis of at least one electrical potential of the first layer and/or of the second layer and/or on the basis of the gas pressure in the cavity, detected by the pressure measuring element.

The evaluation instrument may configured in order to determine the gas alternately or simultaneously on the basis of the electrical potential and on the basis of the gas pressure. In particular, evaluation instrument may be configured in order, for a temporally integrated measurement, to carry out the determination of the gas repeatedly over a predetermined period of time, for example one journey of the vehicle.

Furthermore, a method for operating a device for detecting a parameter of a gas is provided, wherein the device comprises at least one cavity for receiving the gas from an external space, at least one membrane for separating the cavity from the external space, a first side of the membrane, facing toward the external space, comprising a first layer of an electrically conductive material, and a second side, facing toward the cavity and lying opposite the first side, of the membrane comprising a second layer of an electrically conductive material, and at least one section of the membrane comprising an ion-conducting material, and at least one pressure measuring element, arranged on the membrane, for detecting a gas pressure in the cavity, and wherein the method comprises the following steps:

applying an electrical voltage between the first layer and the second layer in order to pump the gas through the membrane from the external space into the cavity; and

detecting an electrical quantity at least at the first layer and/or the second layer and/or at the pressure measuring element, in order to detect the parameter of the gas.

The electrical quantity, if it is detected at the first layer and/or the second layer, may for example be an electrical current strength of a pump current pumping the gas through the membrane. If the electrical quantity is detected the pressure measuring element, it may be an electrical voltage based on an elastic deformation of the pressure measuring element.

According to one embodiment, the method may furthermore comprise a step of reapplying the electrical voltage between the first layer and the second layer in order to pump the gas through the membrane from the cavity into the external space, and correspondingly a step of redetecting the electrical quantity at least at the first layer and/or the second layer and/or at the pressure measuring element, in order to redetect the parameter of the gas. This embodiment allows determination, integrated over time, of the gas or a gas composition in a straightforward, economical and flexible way.

According to another embodiment, the method for operating the device may be carried out as a pulse width modulation method, the step of applying the electrical voltage between the first layer and the second layer being carried out alternately with a step of applying an electrical voltage via the first layer or the second layer in order to heat the section of the membrane. Thus, by means of the method, advantageous combined heating of the membrane and measurement value determination of the gas can be carried out by means of the same device element.

The approach proposed here also provides a device which is configured in order to carry out, or implement, the steps of a variant of a method proposed in corresponding instruments. This alternative embodiment of the invention, in the form of a device, can also achieve the object of the invention rapidly and efficiently.

In the present case, a device may be understood as an electrical apparatus which processes sensor signals and outputs control and/or data signals as a function thereof. The device may comprise an interface, which may be configured as hardware and/or software. In the case of a hardware configuration, the interfaces may for example be part of a so-called system ASIC, which comprises a wide variety of functions of the device. It is, however, also possible for the interfaces to be separate integrated circuits, or to consist at least partially of discrete components. In the case of a software configuration, the interfaces may be software modules, for example existing besides other software modules on a microcontroller.

Advantageously, a computer program product or computer program, having program code which can be stored on a machine-readable carrier or storage medium such as a semiconductor memory, a hard disk memory or an optical memory and is used in order to carry out, implement and/or control the steps of the method according to one of the embodiments described above, in particular when the program product or program is run on a computer or a device.

The approach proposed here will be explained in more detail below by way of example with the aid of the appended drawings, in which:

FIG. 1 shows a cross section of a device for detecting a parameter of a gas according to one exemplary

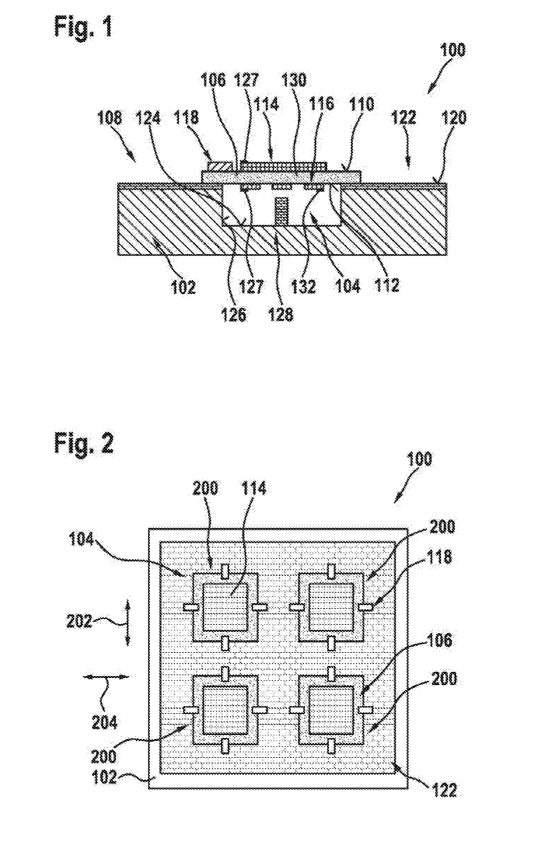

FIG. 2 shows a plan view of a device for detecting a parameter of a gas according to another exemplary embodiment of the present invention;

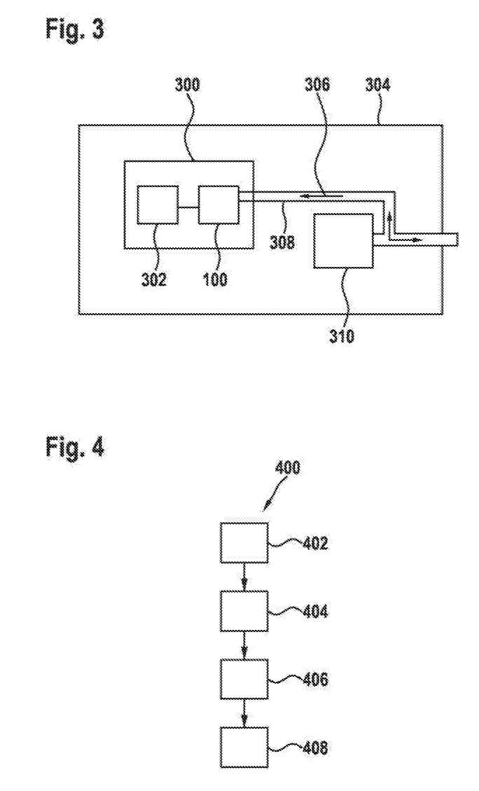

FIG. 3 shows a block diagram of a measuring system for determining a parameter of a gas according to one exemplary embodiment of the present invention, and

FIG. 4 shows a flowchart of a method for operating a device for detecting a parameter of a gas according to one exemplary embodiment of the present invention.

In the following description of favorable exemplary embodiments of the present invention, identical or similar references are used for the elements which are represented in the various figures and have identical or similar effects, repeated description of these elements being omitted.

FIG. 1 shows an outline representation of a cross section of a device 100 for detecting a parameter of a gas according to one exemplary embodiment of the present invention. The device 100 may, for example, be installed and configured in a vehicle in order to detect a concentration of pollutant gases in the exhaust gas of the vehicle. The device 100 may therefore also be referred to as a sensor device, or a sensor. The device 100 comprises a substrate 102, in which a chamber or cavity 104 is applied. The cavity 104 is covered by a membrane 106. The membrane 106 therefore separates the cavity 104 from an external space 108. A first side 110 of the membrane 106 faces toward the external space 108, and a second side 112 of the membrane 106, lying opposite the first side 110, faces toward the cavity 104. The first side 110 of the membrane 106 comprises a first layer 114 of an electrically conductive material, and the second side 112 of the membrane 106 comprises a second layer 116 of an electrically conductive material. Separated from the first layer 114 of an electrically conductive material, a pressure measuring element 118 for detecting a gas pressure in the cavity 104 is arranged on the first side 110 of the membrane 106. The pressure measuring element 118 therefore forms a pressure sensor element of the device 100.

In the exemplary embodiment of the device 100 as shown in FIG. 1, the substrate 102 is formed from silicon. As an alternative, it is also possible to use other materials which are suitable for MEMS technologies. Besides the provision of the cavity 104, the substrate 102 is used inter alia as a carrier, in particular for the membrane 106 and the pressure measuring element 118. The pressure measuring element 118 may also contain—not shown here—other elements necessary for a pressure measurement, for example a temperature sensor or temperature-compensating elements. As a temperature sensor, it is also possible however to use other elements of the sensor, for example the resistor of a heater or a layer 114 or 116 configured as a heater. As shown by the representation in FIG. 1, the cavity 104 has been excavated from a surface or main side 120 of the substrate 102, for example by means of an etching process. A region, enclosing the cavity 104, of the surface 120 of the substrate 102 is covered by an insulation layer 122. As is shown by the cross section of the device 100 in FIG. 1, the cavity 104 is configured as a cuboid trough having a planar rectangular bottom 124 and a wall 126 extending perpendicularly to the bottom 124. The cavity 104 is configured to be shallow by the dimensions of the bottom 124 exceeding a height of the wall 126.

Ideally, the chamber 104 is configured to be as shallow as possible so that, together with a small volume, a large area of the membrane 106 can simultaneously be exposed. In this case, even small amounts of pumped gas can achieve high pressure changes. The height of the chamber wall 126 does, however, have a lower limit since, with too low a distance of the heated membrane 106 from the chamber bottom 124, heat transfer would also occur in this case. Since the surface area to volume ratio of the chamber 106 is determined only by the height of the chamber 104, it is possible to carry out miniaturization of the chamber 104 and adaptation to geometrical requirements of the pressure sensor 118. The minimum size of the chamber or cavity 104 may furthermore be established on the basis of reliability aspects, for example a minimum size required for a pump element in order to ensure a function even in the event of deposits.

The membrane 106 has a rectangular shape corresponding to the bottom 124 of the cavity 104, dimensions of the membrane 106 being greater than the dimensions of the bottom 124 of the cavity 104. As shown by the representation in FIG. 1, a circumferential edge region of the membrane 106 is fixed to the insulation layer 122 of the substrate 102 on an edge region, enclosing the cavity 104, of the substrate 102, and thus separates the cavity 104 from the external space 108. The membrane 106 is made of a resilient material and can curve in the direction of the cavity 104 and in the direction of the external space 108 in response to a pressure prevailing in the cavity 104 relative to the external space 108. In order to allow transport of the gas through the membrane 106, at least one section of the membrane 106 comprises an ion-conducting material. The layers 114, 116 are congruently positioned centrally on the respective sides 110, 112 of the membrane 106, parallel to a plane in which the membrane 106 extends. In the plane of the membrane 106, the layers 114, 116 have smaller dimensions than the membrane 106 us in particular than the cavity 104, and are therefore separated from the substrate 102.

In the exemplary embodiment shown in FIG. 1, the first layer 114 and the second layer 116 of an electrically conductive material are formed from a gas-permeable noble metal. This, however, is not absolutely necessary for the function of the device 100. According to exemplary embodiments, it is also possible to use other metals and/or gas-permeable substances, as well as nonmetals, for the layers 114, 116. In the exemplary device 100 shown in FIG. 1, the first layer 114 and the second layer 116 of an electrically conductive material are used as electrodes for generating a pump current for pumping gas through the membrane 106 from the external space 108 into the cavity 104 and/or from the cavity 104 into the external space 108. For application of an electrical potential to the first layer 114 and the second layer 116, the two layers 114, 116 each comprise at least one electrical contact terminal 127. According to one alternative exemplary embodiment, the device 100 is configured by using the layers 114, 116 in the aforementioned configuration in order to generate an electrical voltage between the first layer 114 and the second layer 116 in the event of diffusion of the gas through the membrane 116.

In the exemplary embodiment of the device 100 as shown in FIG. 1, the pressure measuring element 118 is configured and formed as a strain gauge in order to generate an electrical voltage on the basis of an elastic deformation of the membrane 106 due to gas transport into the cavity 104 or from the cavity 104 on the basis of the pump current. In order to limit a deflection of the membrane 106 in the direction of the cavity 104, the exemplary embodiment of the device 100 as shown in FIG. 1 comprises a stop element 128. In the exemplary embodiment shown in the representation, the stop element 128 is arranged centrally on the bottom 124 of the cavity 104 in the form of a column extending in the direction of the membrane 106. In order to avoid a short circuit between the second layer 116, forming the—in the representation—lower electrode, and the substrate 102, the stop element 128 may, like the insulation layer 122, comprise an electrically insulating material. As an alternative, the stop element may be configured in a conductive, so that for example the pump process is interrupted in the event of contact between the conductive layer 116 and the stop element 128. As an alternative, the cavity may also be produced in such a way that there is contact between 116 and 128 during normal operation and, because of an impermissibly high internal pressure, curvature of the membrane leads to a detectable interruption. By correlation of the signals of the pressure measuring element or elements and the contact with an electrically conductive stop element, function detection or calibration of the pressure measuring elements may also be carried out.

In the exemplary embodiment of the device 100 as shown in FIG. 1, the second or lower layer 116 of the electrically conductive material is configured in a meandering shape in a plane parallel to the plane of the membrane 106, and is in this case additionally used as a heating element for heating a section 130, lying between the layers 114, 116, of the membrane 106. In order to generate an electrical current flow, necessary for the heating function, through the second layer 116, the latter comprises a second electrical contact terminal 132. As shown by the representation in FIG. 1, the pressure measuring element 118 is arranged outside the section 130, to be heated, of the membrane 106.

The exemplary sensor 100 shown in FIG. 1 comprises the membrane 106, which separates the internal space or the cavity 104, and according to exemplary embodiments further internal spaces 104 in the form of a cavity which is closed or limitedly open for diffusion, and the external space 108, as well as the element 106 made of ion-conducting material, which is arranged between the internal space 104 and the external space 108. At least the part 130 of the membrane 106 made of ion-conducting material is configured to be heated. The strain gauge 118 is arranged outside the heated region 130 of the membrane 106. According to exemplary arrangements, the device 100 may also comprise further strain gauges 118, which may be arranged at further positions on the membrane 106 different to a position of the first strain gauge 118.

By means of the ion-conducting element in the form of the membrane 106, the gas or a multiplicity of gases are moved in a defined way from the external space 108 into the internal space or the cavity 104 of the sensor 100, and/or vice versa. This “pumping” of gas leads to pressure differences between the internal space 104 and the external space 108, which are detected by the pressure sensor 118, here in the form of the strain gauge. With detection of the pump current and/or the pressure, the gas concentration can be calculated. If the two parameters are detected simultaneously, the functionality and accuracy of the device 100 can advantageously be increased, or advantageously checked in the scope of an integrated self-test.

In the cross section of an exemplary structure of the sensor 100 as shown in FIG. 1, the cavity 104 is covered by the membrane 106. The bending of the membrane 106 is detected by the measuring element 118, for example piezoelectrically or piezoresistively. The section 130 of the membrane 106, which is in this case the central section, is heated by the membrane heater, here in the form of the lower electrode 116. By virtue of the two electrodes 114, 116 above and below the ion-conducting membrane 106, gas, in particular oxygen, is pumped into and out of the cavity 104 by applying an electrical current. The pressure changes in this case, which can be measured by the bending of the membrane 106. In the structure of the device or the sensor 100 as shown by way of example in FIG. 1, the lower electrode 116 is configured in a meandering shape and is simultaneously used as a heater for the membrane 106. A higher pump current can flow during this outward pumping of gas, so that a short regeneration time until the start of a subsequent measurement can be achieved.

The pumping of the gas into the closed chamber 104 through the ion-conducting element 106 leads to a pressure increase there, which is measured piezoelectrically or piezoresistively by means of the pressure measuring element 118. With detection of the pump current and the pressure, the gas concentration is measured. In an advantageous operating mode of the sensor 100, the gas is pumped first into the chamber 104 and subsequently out of the chamber 104, and both processes are measured. In this way, the function of the sensor 100 as a whole can be monitored in the scope of a self-test. As an alternative, gas which is present only with a small concentration in the external space 108 may also be pumped over a longer period of time, which is accurately defined temporally or is measured, into the cavity 104 with a small current that can be measured only with difficulty. In this case, the gas accumulates in the chamber 104 until the amount of gas pumped into the chamber 104 can be determined with sufficient accuracy by the pressure sensor 118. Before another measurement process, the gas contained in the internal space 104 is then pumped out again, in which case, with integration of the pump current, i.e. the pump charge that has flowed, this process provides additional information about the amount of gas previously accumulated in the chamber 104.

In the concept of an exhaust gas sensor as proposed herein, only the ion-conducting material needs to be brought to a high temperature. Since the ion-conducting properties are in this case required only on the membrane 106, or parts thereof, heating which is very economical in terms of power can be carried out. For the sensor 100 only partially heated in this way, or the partially heated thin-film membrane 106, the power consumption is in particular drastically lower compared with conventional ceramic exhaust gas sensors. The rest of the sensor element 100 can be operated at ambient temperature or at a temperature which is constant but lies only slightly above the ambient temperature, for example by means of the heat dissipation from the heated membrane 106 or by means of a second heater. By the heating in the membrane 106, it is furthermore possible to determine the presence of gas in the chamber 104, and optionally also, with the aid of differing behavior during temperature changes, the composition thereof. When there is gas present in the chamber 104, during heating, a pressure increase which can be measured by the sensor element 118 takes place because of the membrane 106. By virtue of the heating, it is therefore simultaneously possible to carry out a function check or integrity check of the sensor 100. A defined temperature increase must in this case lead to a defined pressure increase, which is optionally established beforehand by means of calibration.

In the exemplary embodiment of the device 100 as shown in FIG. 1, the heater for the membrane 106 is simultaneously used as the lower electrode 116. This is achieved by configuring the second electrically conductive layer 116 as a gas-permeable noble metal layer, for example of Pt or a Pt-Rh alloy. The heatable second electrically conductive layer 116 is structured in a meandering shape and comprises the two electrical terminals 127, 132. In this way, the layer 116 can be used either for the heating, by a different potential being applied to the two terminals 127, 132, or as an electrode, by the same potential being applied to the two terminals 127, 132. For pump purposes, this metal layer 116 can be configured with very low impedance so that the applied heating voltage is only very small and has an almost constant potential in relation to the back electrode, here formed by the first electrically conductive layer 114. In this way, only small charging or polarization effects are formed in the membrane 130 on the side 112, which leads to a smaller influence on the measurement accuracy.

In the operating mode of heating the membrane 106 by a pulse width modulation method, during the off phase a potential may be applied to the lower electrode 116 or a potential applied to the lower electrode 116 may be measured. Advantageously, all electrodes which are connected to the heated ion-conducting layer 106 are connected with high impedance during the application of voltage to the heater 116, in order to avoid charging or polarization effects due to potential differences from the heater 116.

According to alternative exemplary embodiments, the second electrically conductive layer 116 may be used exclusively as an electrode and a separate heater may be installed for heating the membrane 106.

With the aid of a plan view, FIG. 2 shows another exemplary embodiment of the device 100 for detecting a parameter of a gas. As shown by the representation, the substrate 102 of the exemplary embodiment shown in FIG. 2 comprises four cavities 104, which are formed in a square and separated uniformly from one another in the substrate 102. Each of the four cavities 104 is in turn covered by an at least locally ion-conducting membrane 106 comprising a first electrically conductive layer 114 and a second electrically conductive layer 116. A structure of each section of the device 100 that comprises a cavity 104 corresponds to the exemplary embodiment shown in FIG. 1 with only one cavity and also comprises the same elements, with the difference that in the exemplary sensor 100 shown in FIG. 2 each cavity 104 is assigned a multiplicity of four pressure measuring elements 118, here again configured as strain gauges. Each of the four regions of the device 100 that comprise a cavity 104 so to speak forms one of four identical sensor elements 200 of the sensor 100.

As shown by the representation in FIG. 2, for each region of the sensor 100 that comprises a cavity 104, a respective pressure measuring element 118 is arranged centrally on each of the four sides of the rectangular cavity 104, at a transition between the membrane 106 and the insulation layer 122 of the substrate 102 and at a distance from the respective electrically conductive layer 114. According to this arrangement, two strain gauges 118 respectively arranged on two opposite sides of the cavity 104 have a common detection direction 202 denoted by a direction arrow in the representation, which extends transversely to a further common detection direction 204, denoted by means of a direction arrow, of the other two strain gauges 118 respectively arranged on opposite sides of the cavity 104.

The sensor 100, as shown by way of example in FIG. 2, is suitable for use in order to compensate for pressure variations and for integrated measurements. This is carried out, for example, by a first of the sensor elements 200 measuring for example exclusively the ambient pressure, a second or a second and third of the sensor elements 200 measuring with a time offset, but overlapping, the gas concentration by pumping, and a fourth sensor element 200 being pumped empty. Ideally, the function of the sensor elements 200 rotates after a particular time. In the event of failure of one of the elements 200, measurement can advantageously continue to be carried out during emergency operation.

In order to increase the accuracy and in order to be able to compensate for variations in the pressure of the external space 108, according to exemplary embodiments one of the four sensor elements 200 or a further sensor element may be used as a reference pressure sensor without a pump function. A plurality or all of the sensor elements 200 may also have an identical functionality in time-offset operation, for example with a first of the sensor elements 200 pumping gas into its chamber 104, a second of the sensor elements 200 being pumped empty during this time, and a third of the sensor elements 200 being used as a reference element for the varying pressure in the external space 108. According to other exemplary embodiments, at least the temperature and also an exhaust-gas flow rate may by means of further measuring elements—not shown in the figures—in order to be able to deduce the actual flow rate of the exhaust gas and therefore the gas concentration.

By the combination, proposed by way of example in FIG. 2, of a plurality of individual sensors or sensor elements 200 in the device 100, the accuracy of a measurement can be increased by matching the individual elements 200 against one another, for example by means of a pumping method for pumping gas through the membrane 106 and a pressure measurement method using the pressure measuring elements 118. By redundancy of the sensor elements 200, the fault tolerance of the sensor 100, for example used in the on-board diagnostics of a vehicle, is increased. In order to further increase the accuracy, some elements may be used in an identical operating mode (for example pure pressure measurement or pumping up to a particular pressure) at least temporarily or during a calibration, so as to determine respective calibration parameters for each operating mode and for each sensor element relative to the other elements, and store them in a memory of an evaluation device 302 (see FIG. 3). During subsequent use, in order to check the functionality, deviations of the sensor elements from one another may in turn be established and, in the event of an unacceptable extent of the deviation, and evaluation unit may react suitably, for example emit a warning.

Besides the advantage explained above, that the individual elements 200 are operated alternately during normal operation, the exemplary redundant embodiment of the device 100 as proposed in FIG. 2, having a plurality of smaller chambers 104 or sensors 200 offers the advantage of also being able to temporarily operate the sensor elements 200 simultaneously for a function test of the sensor 100. The function check may be carried out by comparing the measurement results of the individual sensors 200 with one another after simultaneous operation. In order also to reduce a mechanical load on the membrane 106 in the event of a very small internal pressure of one or all of the sensor elements 200 after pumping empty, stop elements (not visible in the representation in FIG. 2) for restricting the movement of the membrane 106 are also arranged in the cavities 104 in the exemplary embodiment of the device 100 as shown FIG. 2.

FIG. 3 shows an outline block diagram of an exemplary measuring system 300 for determining a parameter of a gas. The measuring system 300 comprises an exemplary embodiment of the device 100 explained with the aid of FIG. 1, as well as an evaluation device 302 coupled to the device 100, and is employed in a vehicle 304 in order to determine a pollutant gas concentration in an exhaust gas 306 of the vehicle 304.

The vehicle 304 may be a road vehicle such as an automobile or a truck. Via a line system 308 of the vehicle 304, a partial flow of the gas or exhaust gas 306 is diverted and fed to the measuring system 300 in order to expose the sensor 100 to the gas 306. Depending on the configuration of the measuring system 300, the evaluation device 302 is coupled to the first layer of an electrically conductive material and/or to the second layer of an electrically conductive material and/or to the pressure measuring element of the device 100 (this is not shown explicitly in the representation in FIG. 3) and is configured in order to determine the pollutant gas concentration in the exhaust gas 306 on the basis of at least one electrical potential of the first layer and/or of the second layer and/or on the basis of the gas pressure in the cavity of the device 100, detected by the pressure measuring element. The measuring system 300 may be arranged at any desired position in the vehicle 304, for example even far away from an engine compartment 310 of the vehicle 304.

The device 100 illustrated in FIGS. 1 to 3 may be a miniaturized combined gas and pressure sensor based on MEMS technology. According to exemplary embodiments, production of the sensor 100 proposed here is carried out by means of a modified pressure sensor production process. During the sensor production, by using an APSM process, the exposure of the cavity 104 formed from porous material may already be carried out during the application of the ion-conducting material 106 and a subsequent heat treatment, in particular when methods with a high temperature are used for the application or heat treatment of the ion-conducting material 106, for example YSZ, for example pulsed laser deposition with deposition temperatures for example of 800° C. or subsequent heat treatment steps with similar or even higher temperatures.

FIG. 4 shows a flowchart of an exemplary embodiment of a method 400 for operating a device for detecting a parameter of a gas. The method 400 may be configured in order to operate a sensor as proposed with the aid of FIGS. 1 to 3 explained above.

In a step 402, an electrical voltage is applied between a first layer and a second layer of an electrically conductive material of the sensor, in order to pump gas through an ion-conducting membrane arranged between the first and second layers, from an external space into a cavity of the sensor, arranged below the membrane. In a step 404, an electrical quantity is detected at the first layer and/or the second layer and/or at a pressure measuring element of the sensor, arranged on the membrane, in order to detect the parameter of the gas. In a step 406, the electrical voltage is reapplied between the first layer and the second layer in order to pump the gas through the membrane from the cavity into the external space. A step 408 of redetecting the electrical quantity at the first layer and/or the second layer and/or at the pressure measuring element is carried out in order to redetect the parameter of the gas.

According to one embodiment, the method 400 may be configured as a pulse width modulation method. In this case, the step 402 of applying the electrical voltage, or the step 406 of reapplying the electrical voltage, may be carried out alternately with a step of applying an electrical voltage via the first layer or the second layer, in order to heat the membrane.

A pressure sensor/sensor combination constructed according to the concept proposed here, based on ion-conducting material, is suitable for use as a chemical gas sensor, in particular as an exhaust gas sensor for motor vehicles, and for static applications. One main possible application involves use as a lambda probe, optionally with an alternative structure for also detecting further exhaust gas components, such as nitrogen oxides.

The exemplary embodiments described and shown in the figures are only selected by way of example. Different exemplary embodiments may be combined with one another fully or in relation to individual features. One exemplary embodiment may also be supplemented with the features of another exemplary embodiment.

Furthermore, the method steps proposed here may be carried out repeatedly and in a sequence other than that described.

If an exemplary embodiment comprises an “and/or” conjunction between a first feature and a second feature, this is to be interpreted as meaning that the exemplary embodiment according to one embodiment comprises both the first feature and the second feature, and according to another embodiment either only the first feature or only the second feature.

1. A device for detecting a parameter of a gas comprising:
a body that defines at least one cavity configured to receive a gas from an external space;
at least one membrane configured to separate the cavity from the external space, the at least one membrane including:
a first side facing toward the external space and including a first layer of an electrically conductive material;
a second side, facing toward the cavity and lying opposite the first side, the second side including a second layer of the electrically conductive material; and
ion-conducting material integrated with at least a section of the at least one membrane; and
at least one pressure measuring element arranged on or in the at least one membrane, and configured to detect a pressure of the gas in the cavity.

2. The device as claimed in claim 1, wherein the first layer the at least one membrane and the second layer are configured to at least one of:
pump the gas through the at least one membrane in response to an application of an electrical voltage between the first layer and the second layer; and
generate an electrical voltage between the first layer and the second layer in response to a diffusion of the gas through the membrane.

3. The device as claimed in claim 1, wherein at least one of the first layer and the second layer includes a first electrical contact terminal and a second electrical contact terminal, and is configured to heat at least a section of the at least one membrane in response to an electrical current flow between the first electrical contact terminal and the second electrical contact terminal.

4. The device as claimed in claim 3, wherein the pressure measuring element is arranged outside the section of the at least one membrane configured to be heated by the at least one of the first layer and the second layer.

5. The device as claimed in claim 1, wherein at least one of the first layer and the second layer has a meandering shape.

6. The device as claimed in claim 1, further comprising a stop element configured to limit a deflection of the at least one membrane.

7. The device as claimed in claim 1, further comprising:
at least one second pressure measuring element disposed at a further position that is different to a position of the at least one pressure measuring element on the at least one membrane, such that a detection direction of the at least one pressure measuring element is different to a detection direction of the at least one second pressure measuring element.

8. The device as claimed in claim 1, wherein:
the body further defines at least one further cavity configured to receive the gas from the external space; and
the device further comprises:
at least one further membrane configured to separate the further cavity from the external space; and
at least one further pressure measuring element positioned on the at least one further membrane, and configured to detect a further a pressure of the gas in the further cavity, the at least one further membrane including:
a first side facing toward the external space, having a further first layer;
a second side facing toward the further cavity and lying opposite the first side of the further membrane, and having a further second layer; and
ion conducting material integrated with at least one section of the at least one further membrane.

9. A measuring system for determining a parameter of a gas, comprising:
a device that includes:
a body that defines at least one cavity configured to receive a gas from an external space;
at least one membrane configured to separate the cavity from the external space, the at least one membrane having:
a first side facing toward the external space and including a first layer of an electrically conductive material; and
a second side facing toward the cavity and lying opposite the first side, the second side including a second layer of the electrically conductive material; and
ion-conducting material integrated with at least a section of the at least one membrane; and
at least one pressure measuring element arranged on or in the at least one membrane and configured to detect a pressure of the gas in the cavity; and
an evaluation instrument coupled to at least one of the first layer, the second layer, and the pressure measuring element and configured to determine the parameter of the gas with reference to at least one of (i) at least one electrical potential of at least one of the first layer and the second layer, and (ii) the gas pressure in the cavity detected by the pressure measuring element.

10. A method of operating a device for detecting a parameter of a gas, comprising:
pumping a gas from an external space into a cavity defined by a body of the device through a membrane configured to separate the external space from the cavity by applying an electrical voltage between (i) a first layer of an electrically conductive material included on a first side of the membrane facing towards an external space and (ii) a second layer of the electrically conductive material included on a second side of the membrane facing toward the cavity and lying opposite the first side, wherein ion-conducting material is integrated with at least one section of the membrane; and
detecting an electrical quantity a at least one of the first layer, the second layer, and a pressure measuring element positioned on the membrane and configured to detect a pressure of the gas in the cavity, in order to detect the parameter of the gas.

11. The method as claimed in claim 10, further comprising:
pumping the gas in the cavity through the membrane and into the external space by reapplying the electrical voltage between the first layer and the second layer; and
redetecting the electrical quantity of the at least one of the first layer, the second layer, and the pressure measuring element in order to redetect the parameter of the gas.

12. The method as claimed in claim 10, wherein:
the method is a pulse width modulation method; and
the method further comprises alternating between the applying of the electrical voltage between the first layer and the second layer and applying an electrical voltage via the first layer or the second layer in order to heat the at least section of the membrane integrated with ion-conducting material.

13. The device of claim 1, wherein the device is configured to:
produce an electrical voltage between the first layer and the second layer in order to pump the gas from the external space into the cavity through the at least one membrane; and
detect an electrical quantity of at least one of the first layer, the second layer, and the pressure measuring element, in order to detect a parameter of the gas.

14. The method of claim 10, wherein the method is embodied as a computer program that, when executed by a device, causes the device to carry out the method.

15. The method of claim 14, wherein the computer program is stored on a machine-readable storage device.

16. The device of claim 1, wherein the pressure measuring element includes a temperature measuring instrument configured to measure a temperature of the gas in the cavity.

17. The device of claim 6, wherein the stop element is positioned on a bottom of the cavity.
